(19) United States
(12) Patent Application Publication
(10) Pub. No.: US 2016/0112794 A1
(43) Pub. Date: Apr. 21, 2016

(54) EXTENSION DEVICE AND CONNECTING METHOD THEREOF

(71) Applicant: Much-ip Co., Ltd., Hsinchu County (TW)

(72) Inventors: Shoa-Hung LO, Hsinchu County (TW); Ming-Chou LEE, Hsinchu County (TW)

(21) Appl. No.: 14/517,032

(22) Filed: Oct. 17, 2014

(51) Int. Cl. H04R 3/00; G06F 3/16

(52) U.S. Cl. CPC H04R 3/00; G06F 3/165

(57) ABSTRACT

An extension device that connects to an electronic apparatus to be embedded in said extension device is provided. The extension device comprises: a physical connection interface configured to connect to a physical connection interface of the electronic apparatus; an input interface configured to receive user input and to transmit user input to the electronic apparatus via the physical connection interfaces; a battery module configured to supply electrical power to the electronic apparatus; and a speaker module configured to receive audio output signal from the electronic apparatus and to play accordingly.

### CROSS REFERENCE TO RELATED APPLICATIONS

This application claims priority to Taiwanese patent application, No. 102139450, filed on Oct. 31, 2013, entitled “Extension Device and Connecting Method Thereof”, which is hereby incorporated by reference in its entirety.

### BACKGROUND OF THE INVENTION

1. Field of the Invention

The present invention relates to an extension device, and more particularly, to an extension device for embedding an electronic.

2. Description of the Prior Art

In fairly recent times, smart electronic apparatus have quickly become a daily necessity for many people. Generally speaking, smart electronic apparatus such as smartphones and tablets are designed to provide visual information to users. In other words, the main design goal of these smart electronic apparatus is to output information. Conversely, unlike desktop or laptop computers, smart electronic apparatus are not designed to process large quantities of user data input.

On the premise of maximizing user convenience, the traditional mouse and keyboard may be used via a wireless interface to achieve normal data entry functionality on a smart electronic apparatus. However, many games are designed to make use of angular accelerometers, gyroscopes, or sensors built into the smart electronic apparatus. As such, the input mechanism and the design of the apparatus itself are key to these game designs. For example, in car racing and flight simulation games, the player handles the smart electronic apparatus and presses buttons to manipulate cars or flying vehicles. This type of program requires various kinds of user input interfaces other than a touch screen, as well as a more ergonomic exterior shell for the smart electronic apparatus. Moreover, with smart electronic apparatus, visual and audio user experience is often sacrificed for user mobility.

As a consequence, there exists a market demand for an extension device which can fulfill the extension requirements of a smart electronic apparatus and allow users to input data conveniently without sacrificing visual and audio performance.

As can be seen from the above, it is clear that the prior art still has various shortcomings. Many unsuccessful attempts have been made in order to solve these problems, and ordinary products and methods have failed to provide an appropriate solution. Thus, there is a need in the industry for a novel device to solve these problems.

### SUMMARY OF THE INVENTION

In order to meet the market needs above, the present invention provides various embodiments described below.

In one embodiment, an extension device that connects to an electronic apparatus to be embedded in said extension device is provided. The extension device comprises: a physical connection interface configured to connect to a physical connection interface of the electronic apparatus; an input interface configured to receive user input and to transmit user input to the electronic apparatus via the physical connection interfaces; a battery module configured to supply electrical power to the electronic apparatus; and a speaker module configured to receive audio output signal from the electronic apparatus and to play accordingly.

In another embodiment, a connecting method for connecting an electronic apparatus to be embedded is provided. The connecting method comprises: connecting a physical connection interface of the electronic apparatus to a physical connection interface of the extension device; receiving user input via an input interface of the extension device and transmitting user input to the electronic apparatus via the physical connection interfaces; supplying electrical power stored in a battery module of the extension device to the electronic apparatus; and receiving audio output signal from the electronic apparatus via the physical connection interface of the extension device and playing audio output signal accordingly through a speaker module of the extension device.

In summary, the extension device and the connecting method thereof provided by the present invention are used to expand the input and output capabilities of the electronic apparatus to enrich user experience.

The above description is only an outline of the technical schemes of the present invention. Preferred embodiments of the present invention are provided below in conjunction with the appended drawings to enable one with ordinary skill in the art to better understand said and other objectives, features and advantages of the present invention and to make the present invention accordingly.

### BRIEF DESCRIPTION OF THE DRAWINGS

The present invention can be more fully understood by reading the following detailed description of the preferred embodiments, with reference made to the accompanying drawings, wherein:

FIG. 1 depicts a traditional electronic apparatus.

FIG. 2 illustrates an extension device in accordance with an embodiment of the present invention.

FIG. 3 shows a schematic block diagram of an extension device according to another embodiment of the present invention.

FIG. 4 depicts a flowchart diagram of a connecting method in accordance with an embodiment of the present invention.

### DETAILED DESCRIPTION OF THE PREFERRED EMBODIMENTS

Some embodiments of the present invention are described in detail below. However, in addition to the descriptions given below, the present invention can be applied to other embodiments, and the scope of the present invention is not limited by such specifics, but rather by the scope of the claims. Moreover, for better understanding and clarity of description, some components in the drawings may not necessarily be drawn to scale, as some components may be exaggerated relative to others and irrelevant parts may be omitted.

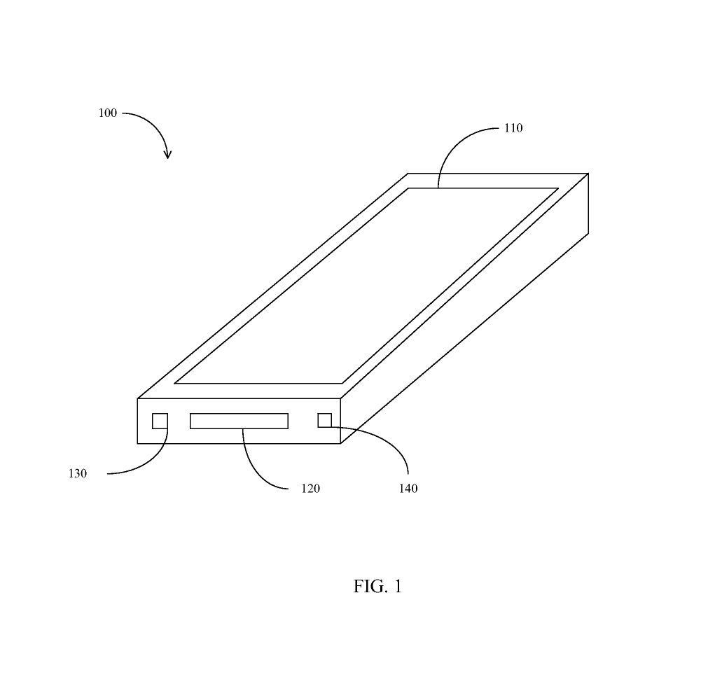

Please refer to FIG. 1, which depicts a traditional electronic apparatus 100. One with ordinary skill in the art would understand that the electronic apparatus 100 may be a smart electronic apparatus, such as a smartphone, tablet, PDA (personal digital assistant), etc. The electronic apparatus 100 may comprise at least a touch sensitive screen 110, a physical connection interface 120, a microphone module 130, and a speaker module 140.

The electronic apparatus 100 may comprise a processor module, a wireless network module, a memory module, an accelerometer, a gyroscope, an attitude meter, and various circuits for performing phone calls and executing various types of programs. The programs may include voice communication programs utilizing the wireless network module, visual communication programs, textual communication programs, and gaming programs. Such programs output visual and audio information via the touch sensitive screen 110 and the speaker module 140, respectively. At the same time, the programs receive user input via the touch sensitive screen 110 and the microphone module 130. The programs and operating system executed by the electronic apparatus may be connected to an external electronic device, such as a personal computer or battery charging module, via the physical connection interface 120.

As described earlier, the design goal of the electronic apparatus 100 is primarily portability and not user input functionality. To begin with, the touch sensitive screen 110 is small. Due to power and volume constraints, the speaker module 140 may only produce a single sound channel. Hence, the present invention provides an extension device for the electronic apparatus 100 such that the input/output performance of the electronic apparatus may be enhanced to enrich user experience.

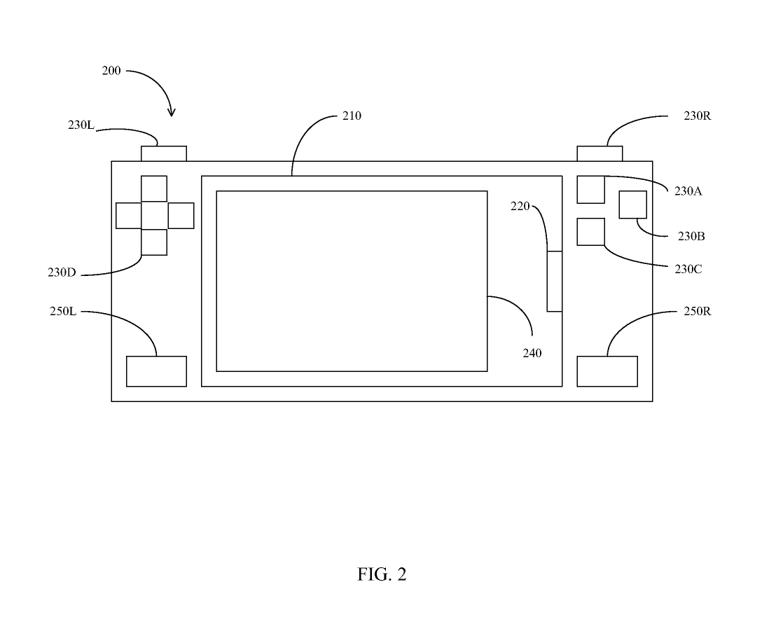

Please refer to FIG. 2, which illustrates an extension device 200 in accordance with an embodiment of the present invention. FIG. 2 illustrates a top-down view of the extension device 200. One with ordinary skill in the art would understand that the extension device 200 shown in FIG. 2 is only one embodiment of the present invention. The present invention does not limit the appearance or shape of the extension device 200, as long as part of or the entire electronic apparatus 100 may be embedded in the extension device 200 and the physical connection interface 120 of the electronic apparatus 100 may connect to the extension device 200.

The extension device 200 comprises at least an indentation 210, a physical connection interface 220, an input interface 230 including multiple buttons, a battery module 240, and a speaker module 250. As described above, the indentation 210 is configured to contain at least part of or the entire electronic apparatus 100 such that the electronic apparatus 100 is embedded in the extension device 200. The shape of the indentation 210 should match the appearance of the electronic apparatus 100. However, the shape of the indentation 210 and the electronic apparatus 100 need not be identical. Moreover, the indentation 210 need not be close-fitting. In addition, the shape of the indentation 210 may change to adapt to different electronic apparatus 100. One with ordinary skill in the art would understand that although the indentation 210 is used to embed the electronic apparatus 100, the embedding design is not limited to an indentation. Any type of clamp or fastener may be used to embed the electronic apparatus 100 in the extension device 200.

The physical connection interface 200 is configured to connect to the physical connection interface 120 of the electronic apparatus 100. The present invention does not limit the form or specification of the physical connection interface 200, as long as the electrical power, data, image, and voice data described below may be transmitted through the physical connection interface 200, which could be utilized in the present invention.

The input interface 230 of the extension device 200 shown in FIG. 2 comprises at least multiple buttons 230, such as left and right direction buttons 230L and 230R, a four-way directional pad 230D, and general purpose control buttons 230A, 230B, and 230C. Some programs executed by the electronic apparatus 100 may be notified when the user presses a button of the input interface 230 according to control signals transmitted through the physical connection interface 120. As already mentioned, a user may manipulate cars or flight vehicles in racing car games or flight simulation games run on the electronic apparatus 100 by controlling the multiple buttons 230. One with ordinary skill in the art would understand that although the input interface 230 shown in FIG. 2 is implemented by multiple buttons, the input interface 230 may comprise other kinds of input devices such as a tracking ball, touch sensitive panel, accelerometer, gyroscope, attitude sensing module, etc. The present invention does not limit the types of input interface 230, as long as the electronic apparatus 100 may be controlled by user input via the physical connection interface 220.

As shown in FIG. 2, the battery module 240 contained in the extension device 200 provides power to the circuits and modules of the extension device 200. Moreover, when the electronic apparatus 100 is connected to the extension device 200, the battery module 240 may provide electrical power to the electronic apparatus through the physical connection interface 220. In another embodiment, the electronic apparatus 100 may be wirelessly charged by using electrical power provided by the battery module 240.

In the embodiment shown in FIG. 2, the speaker module 250 comprises at least two speakers, such as a left speaker 250L and a right speaker 250R. The two speakers can provide stereo audio. One with ordinary skill in the art would understand that although speakers 250L and 250R are contained in the extension device 200 shown in FIG. 2, this does not limit the number of speakers comprising the speaker module 250, as long as the extension device 200 may receive audio output signal from the electronic apparatus 100 via the physical connection interface 200 such that the speaker module 250 plays according to the audio output signal.

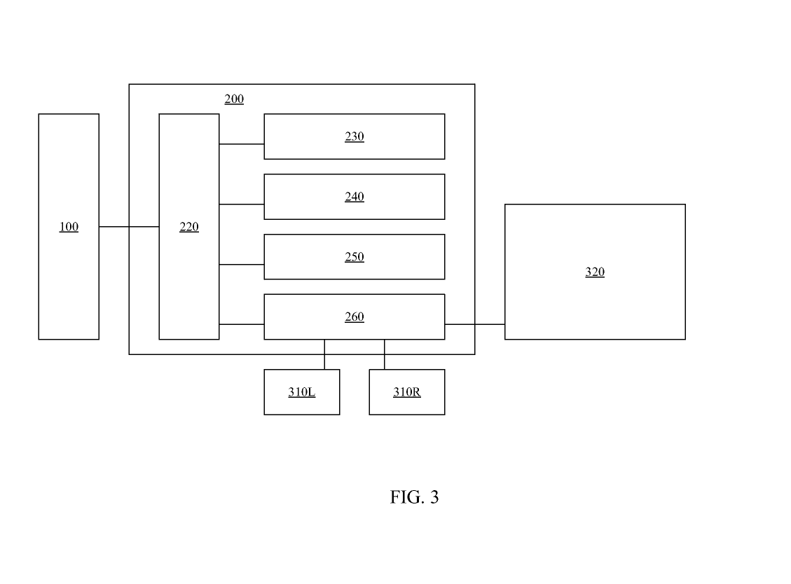

Please refer to FIG. 3, which shows a schematic block diagram of an extension device 200 according to another embodiment of the present invention. If one compares the extension device 200 shown in FIG. 3 to the extension device 200 shown in FIG. 2, it may be noted that the extension device 200 shown in FIG. 3 comprises the same physical connection interface 220, input interface 230 that includes multiple buttons, battery module 240, and speaker module 250. The input interface 230, the battery module 240 and the speaker module 250 are connected to the physical connection interface 220. The extension device 200 is configured to receive user input via the input interface 230 and to transmit user input to the electronic apparatus 100 via the physical connection interface 220; to output electrical power contained in the battery module 240 to the electronic apparatus 100; and to receive audio output signal from the electronic apparatus 100 via the physical connection interface 220 and to play audio output signal from the speaker module 250 accordingly.

The extension device 200 shown in FIG. 3 further comprises a wireless transmission module 260 which is configured to wirelessly connect to at least one external display module 320. The extension device 200 is configured to receive visual output signal from the electronic apparatus 100 via the physical connection interface 220 and to control the external display module 320 to display visual output signal accordingly. In some examples where the electronic apparatus 100 executes certain types of programs, the external display module 320 displays the same content as that displayed by the touch screen 110 of the electronic apparatus 100. Alternatively, when the electronic apparatus executes other types of programs, the external display module 320 displays content that is different from that displayed by the touch screen 110 of the electronic apparatus 100. In some embodiments, the type of programs comprises one of the following: voice communication programs, visual communication programs, and textual communication programs. One with ordinary skill in the art would understand that the present invention is not limited to these programs. For example, in response to a notification of voice, visual, or textual communication received by the electronic apparatus 100, the electronic apparatus 100 may notify the extension device 200 to cease outputting any visual information to the external display module 320 in order to preserve privacy.

In one embodiment, the wireless transmission module 260 is configured to connect to at least one external speaker module 310. The extension device 200 is configured to receive audio output signal from the electronic apparatus 100 via the physical connection interface 220 and to control the external speaker module 310 to play the audio output signal accordingly.

As shown in FIG. 3, the external speaker module 310 comprises a left speaker 310L and a right speaker 310R. In one embodiment, the speaker module 140 inside the electronic apparatus 100 mutes and only the external speaker module 310 plays sound. In other words, once the physical connection interface 220 of the extension device 200 is connected to the physical connection interface 120 of the electronic apparatus 100, the speaker of the electronic apparatus 100 ceases to play sound. Now refer back to FIG. 2, which illustrates the electronic apparatus 100 embedded in the extension device 200, and one may observe that the sound propagation path of the speaker module 140 of the electronic apparatus 100 may be blocked by the extension device 200, causing the sound quality to degrade.

In an alternative embodiment, the speaker module 140 inside the electronic apparatus 100 mutes and only the speaker module 250 plays sound. In another alternative embodiment, the speaker module 140 inside the electronic apparatus 100 mutes and the speaker module 250 of the extension device 200 as well as the external speaker module 310 plays sound. In other embodiments, the speaker module 140 of the electronic apparatus 100, the speaker module 250 of the extension device 200, and the external speaker module 310 play sound simultaneously.

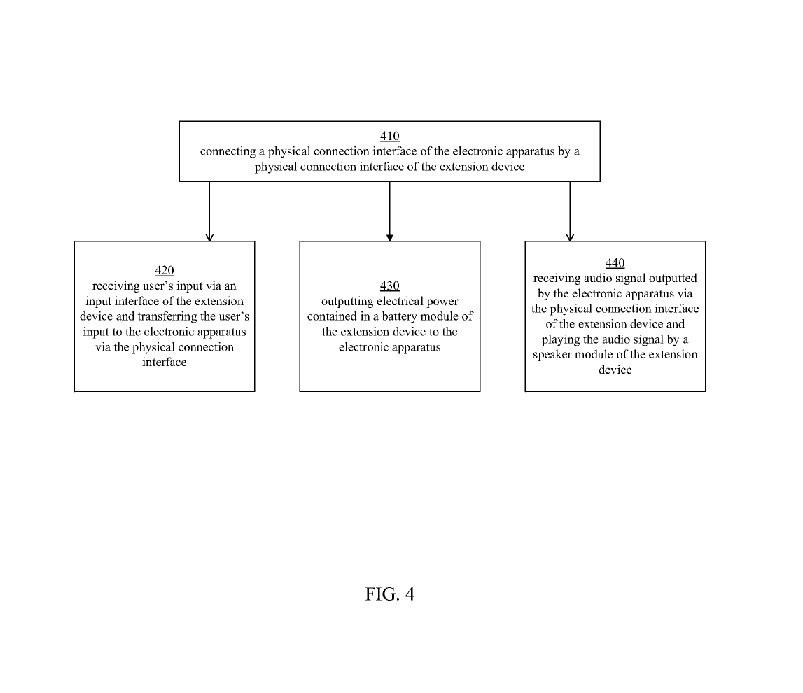

Please refer to FIG. 4, which shows a connecting method according to an embodiment of the present invention. The connecting method is configured to connect an extension device to an electronic apparatus embedded in an extension device. The connecting method comprises the following steps:

Step 410: connecting a physical connection interface of the electronic apparatus to a physical connection interface of the extension device.

Step 420: receiving user input via an input interface of the extension device and transmitting user input to the electronic apparatus via the physical connection interface.

Step 430: supplying electrical power contained in a battery module of the extension device to the electronic apparatus.

Step 440: receiving audio output signal from the electronic apparatus via the physical connection interface of the extension device and playing the audio output signal via a speaker module of the extension device.

In the flowchart shown in FIG. 4, step 410 precedes steps 420, 430 and 440. The present invention does not limit the order of execution of steps 420, 430, and 440. In one embodiment, if the extension device is capable of wireless charging, step 430 need not follow step 410.

One with ordinary skill in the art would understand that the connecting method may be embodied as shown in FIG. 2 and FIG. 3. As such, no further elaboration is included here.

In summary, the extension device and the connecting method thereof provided by the present invention are used to expand the input and output capabilities of the electronic apparatus to enrich user experience.

The above embodiments are only used to illustrate the principles of the present invention and should not be construed as limiting the present invention in any way. The above embodiments may be modified by those with ordinary skill in the art without departing from the scope of the present invention as defined in the following appended claims.

What is claimed is:

1. An extension device for connecting to an electronic apparatus to be embedded in the extension device, comprising:
a physical connection interface configured to connect to a physical connection interface of the electronic apparatus;
an input interface configured to receive user input and to transmit user input to the electronic apparatus via the physical connection interfaces;
a battery module configured to supply electrical power to the electronic apparatus; and
a speaker module configured to receive audio output signal from the electronic apparatus and to play accordingly.

2. The extension device of claim 1, wherein the speaker module is configured to play multiple sound channels contained in the audio output signal.

3. The extension device of claim 1, wherein a speaker module of the electronic apparatus is capable of playing one single sound channel.

4. The extension device of claim 3, wherein the speaker module of the electronic apparatus stops playing in response to the connecting of the extension device to the electronic apparatus via the physical connection interfaces.

5. The extension device of claim 1, wherein further comprises a wireless transmission module configured to connect to at least one external speaker module wirelessly and to command the at least one external speaker module to play audio output signal from the electronic apparatus received via the physical connection interfaces.

6. The extension device of claim 1, wherein further comprises a wireless transmission module configured to connect to at least one external display module wirelessly and to command the at least one external display module to play visual output signal from the electronic apparatus received via the physical connection interfaces.

7. The extension device of claim 6, wherein the content displayed on the external display module is the same as the content displayed on a touch sensitive screen of the electronic apparatus.

8. The extension device of claim 6, wherein the content displayed on the external display module is different from the content displayed on a touch sensitive screen of the electronic apparatus when the electronic apparatus is executing a first program.

9. The extension device of claim 8, wherein the first program comprises one of the following:
voice communication program;
visual communication program; and
textual communication program.

10. A connecting method for connecting an electronic apparatus to be embedded to an extension device, comprising:
connecting a physical connection interface of the electronic apparatus to a physical connection interface of the extension device;
receiving user input via an input interface of the extension device and transmitting user input to the electronic apparatus via the physical connection interfaces;
supplying electrical power stored in a battery module of the extension device to the electronic apparatus; and
receiving audio output signal from the electronic apparatus via the physical connection interface of the extension device and playing audio output signal via a speaker module of the extension device accordingly.

11. The connecting method of claim 10, wherein the speaker module is configured to play multiple sound channels contained in the audio output signal.

12. The connecting method of claim 10, wherein a speaker module of the electronic apparatus is capable of playing one single sound channel.

13. The connecting method of claim 12, wherein the speaker module of the electronic apparatus stops playing in response to the connecting of the extension device to the electronic apparatus via the physical connection interfaces.

14. The connecting method of claim 10, wherein further comprises connecting at least one external speaker module wirelessly to a wireless transmission module of the extension device and commanding the at least one external speaker module to play audio output signal from the electronic apparatus received via the physical connection interfaces.

15. The connecting method of claim 10, wherein further comprises connecting at least one external display module wirelessly to a wireless transmission module of the extension device and commanding the at least one external display module to play visual output signal from the electronic apparatus received via the physical connection interfaces.

16. The connecting method of claim 15, wherein the content displayed on the external display module is the same as the content displayed on a touch sensitive screen of the electronic apparatus.

17. The connecting method of claim 15, wherein the content displayed on the external display module is different from the content displayed on a touch sensitive screen of the electronic apparatus when the electronic apparatus is executing a first program.

18. The connecting method of claim 17, wherein the first program comprises one of the following:
voice communication program;
visual communication program; and
textual communication program.
